(19) United States
(12) Patent Application Publication
(10) Pub. No.: US 2003/0066956 A1
(43) Pub. Date: Apr. 10, 2003

(54) Optical tools manipulated by optical traps

(76) Inventors: Lewis Gruber, Chicago, IL (US); Kenneth Bradley, Hinsdale, IL (US)

Correspondence Address: SONNENSCHEIN NATH & ROSENTHAL, P.O. BOX 061080, WACKER DRIVE STATION, CHICAGO, IL, 60606-1080, US

(21) Appl. No.: 10/232,687

(22) Filed: Sep. 3, 2002

Related U.S. Application Data
(60) Provisional application No. 60/316,917, filed on Aug. 31, 2001.

(51) Int. Cl. H01S 1/00

(52) U.S. Cl. 250/251

(57) ABSTRACT

Micrometer and nanometer-sized tools (referred to as MOTS and NOTS, respectively) are manipulated by optical traps and are able to alter the physical, chemical, or electronic structure or orientation of a workpiece.

The present invention claims priority from U.S. provisional application No. 60/316,917, dated Aug. 31, 2001, which is herein incorporated by reference.

### BACKGROUND OF THE INVENTION

1. Field of the Invention

The present invention relates generally to micrometer sized optical tools (MOTS) and nanometer sized optical tools (NOTS) for altering the physical, chemical or electronic structure or orientation of a workpiece capable of manipulation by optical traps. Such tools are collectively referred to herein as optical tools. In particular, the invention relates to NOTS & MOTS manipulated by optical traps.

2. Discussion of the Related Art

A particle may be held or moved with optical “traps”, also called optical “tweezers” as taught by Ashkin in U.S. Pat. No. 4,893,886 (see also FIG. 27). It is also know in the art to optically trap multiple particles with multiple, simultaneously-generated and simultaneously-controlled optical traps. (See generally U.S. Pat. No. 6,055,106 issued to Grier & Dufresne.) Sophisticated manipulations of objects by optical trapping with control of traps in three dimensions may be performed, for example, by using the BioRyx™ 200 system (available from Arryx, Inc., Chicago, Ill.).

One explanation of the mode of operation of an optical trap is that the gradient forces of a focused beam of light illuminating a particle trap that particle based on the dielectric constant of the particle. A particle having a dielectric constant higher than that of the surrounding medium will move to the region of an optical trap where the electric field is the highest, to minimize the particle's energy.

Other types of optical traps that may be used to optically manipulate particles include, but are not limited to, optical vortices, optical bottles, optical rotators and light cages. An optical vortex produces a gradient surrounding an area of zero electric field which is useful to manipulate particles with dielectric constants lower than the surrounding media, or which are reflective, or other types of particles which are repelled by an optical trap. To minimize its energy, such a particle will move to the region where the electric field is the lowest, namely the zero electric field area at the focal point of an appropriately shaped laser beam. The optical vortex provides an area of zero electric field much like the hole in a doughnut (toroid). The optical gradient is radial with the highest electric field at the circumference of the doughnut. The optical vortex detains a small particle within the hole of the doughnut. The detention is accomplised by slipping the vortex over the small particle along the line of zero electric field.

The optical bottle differs from an optical vortex in that it has a zero electric field only at the focus and a non-zero electric field at an end of the vortex. An optical bottle may be useful in trapping atoms and nanoclusters which may be too small or too absorptive to trap with an optical vortex or optical tweezers. (See J. Arlt and M. J. Padgett, “Generation of a beam with a dark focus surrounded by regions of higher intensity: The optical bottle beam,” Opt. Lett. 25, 191-193, 2000.) The optical rotator is a type of optical trap which provides a pattern of spiral arms. Changing the pattern causes trapped objects to rotate. (See L. Paterson, M. P. MacDonald, J. Arlt, W. Sibbett, P. E. Bryant, and K. Dholakia, “Controlled rotation of optically trapped microscopic particles,” Science 292, 912-914, 2001.) This class of tool may be useful for manipulating non-spherical particles and driving MEMs devices or nano-machinery.

The light cage (see Neal, U.S. Pat. No. 5,939,716) is loosely, a macroscopic cousin of the optical vortex. A light cage forms a ring of optical traps which surround a particle too large, too reflective, or with a dielectric constant lower than the surrounding media.

In general, traps are used to either manipulate materials such as in the area of constructing arrays of dielectric particles, or manipulating and/or investigating biological or chemical materials, as taught in pending U.S. patent application Ser. No. 09/886,802, filed Jun. 20, 2001, entitled “Configurable Dynamic Three Dimensional Array.” A miniaturized transponder combined with a bead based probe is described in U.S. Pat. Nos. 5,641,634 and 6,001,571 issued to Mandecki.

However, prior art optical tools are not able to provide the functionality of hammers, saws, drills, punches, files, wrenches, screwdrivers and levers etc., and are not able to be used to obtain fluid or particulate samples from a material under investigation.

### SUMMARY OF THE INVENTION

The present invention provides a novel pallet of MOTS and NOTS. The MOTS and NOTS are formed of materials which are manipulated via action by one or more optical traps.

The present invention also provides a method of manipulating an object (generally referred to as a workpiece) with an optical tool by grasping the optical tool in the illumination of an optical trap, optionally holding the workpiece in the illumination of at least one optical trap and manipulating the workpiece with the optical tool.

In one embodiment consistent with the present invention, a method of forming an optical tool includes forming a tool from a material of a size and shape adapted for manipulation by at least one optical trap, wherein the forming step is accomplished by removing material by drilling or etching from a tool blank, or by stereolithography using a polymer. In one embodiment consistent with the present invention, the tool blank is a microsphere.

In another embodiment consistent with the present invention, the optical tool includes a main body formed of a material of a size and shape adapted for manipulation by at least one optical trap.

NOTS and MOTS included within the scope of the present invention, include, but are not limited to hammers, saws, drills, punches, levers, files, wrenches, screwdrivers, knives, awls, screwdrivers, and wrenches. Also included are optical tools useful to obtain fluid or particulate samples from the material under investigation. Further included are optical tools which act as a scribe to physically place a mark, patter, or label on a structure. Yet further included are optical grinders which physically cut a guide, groove, well, or channel in a material at a micron or submicron size. Still further included are optical tools with a magnetized or charged substrate, and optical tools with anisotripic functionality.

All optical tools described herein are constructed of materials which may be manipulated by optical traps. In most instances, the materials are dielectric. The surface characteristics of the MOTS and NOTS which are used to physically interact with other items may be homogeneous, or non-homogeneous. Surface characteristics which may be selected include, but are not limited to, porosity, hardness, abrasives, lubricity, and regularity. In some instances a MOT or NOT may have regions each with different surface characteristics.

In many instances the functionality of a MOT or NOT will set the parameters for the selection of the material of which it is constructed. Optical tools which are used to hammer, pry, apply torque to, cut, scratch, punch, grind, abrade, drill or file another material will preferably be constructed of a material with a high tensile strength and hardness greater than the material they are being applied to.

Although in many instances, plastic is a preferred substrate or blank material for MOTS or NOTS, in some instances suitable inorganic materials such as glass, metals, silica, diamond, quartz, chelating agents, nylon or a composite may be selected. Likewise, where appropriate, organic materials, such as proteins, lipids, nucleic acids and carbohydrates, may be selected. Any of the optical tools may have a label such as a dye, fluorophore, phosphor, quantum dot, metallic, transponder, catalytic, enzyme, or radioactive, chemiluminescent or photochromic material within the substrate which may be used to identify the MOT or NOT.

In one embodiment consistent with the present invention, to investigate materials such as plant or animal cells, organelles, proteins, polysaccharides and genetic material therein, MOTS and NOTS in the form of hollow structures which perform a capillary function may be positioned and controlled with optical traps to extract sample material which may be fluid or particulate.

MOTS and NOTS include objects functionalized to perform selected actions. MOTS and NOTS according to one embodiment consistent with the present invention, may have one or more charged, magnetic or radioactive region. MOTS and NOTS according to another embodiment consistent with the present invention, may have hydrogen bonding, hydrophobic, hydrophilic, acidic or basic regions formed thereon. Additionally, MOTS and NOTS according to yet another embodiment consistent with the present invention, may simply be a carrier particle having only the functionality of supporting the one charged, magnetic or radioactive region.

MOTS and NOTS according to another embodiment consistent with the present invention, may be formed with anisotropic functionality useful to investigate properties within materials, structures or biological systems based on the interaction of the material. For example, a MOT or NOT may have different charges, differing chemical properties (hydrophobic versus hydrophilic, or acid versus base) or differing surface regularity on each end or side. Such MOTS and NOTS exemplify functionalized optical tools according to an embodiment consistent with the present invention wherein the intended activities of the functionalized areas may be directed or localized by manipulating their supporting MOT or NOT with an optical tool. For example, in another embodiment consistent with the present invention, a chemically-functionalized portion of a MOT or a NOT may be transported to a location where the MOT or NOT is affixed to an object having on its surface a group reactive with the portion.

In another embodiment consistent with the present invention, MOTS and NOTS may be used for investigating plant and animal cells, organic and inorganic chemicals, genetic and other biological material such as proteins, ligands and polysaccharides. In yet another embodiment consistent with the present invention, the MOTS and NOTS are also useful for micro- and nano-scale fabrication of inorganic, organic and biological materials. Examples of MOT or NOT usage include building other MOTS & NOTS, constructing MEMS, building nanometer sized machines or structures, and adding or removing genetic material or proteins within a cell.

The MOTS and NOTS consistent with another embodiment of the present invention, which are contained within optical traps, may be used for imprinting a micron or submicron size pattern or identifier mark on such a material or structure as described above. The pattern may be a simple identifier such as a tag, brand or logo. The pattern may contain data such as a serial number, bar code or data matrix. Such printing, for example, may be implemented by employing soft lithography to manufacture a chip with reservoirs and a substrate. Using optical traps to grab and move beads coated with material to be imprinted, the reservoirs may be first loaded with the beads, and then the beads may be pressed against the substrate to imprint the material. In order to affix the material to the substrate, the material may be selected to be reactive with or attracted to the substrate, it may be activated by light, heat or chemicals, or it may be trapped by scratches or abrasions in the substrate. In another example, beads coated with an ink may be individually and simultaneously contacted as printing elements.

In one embodiment consistent with the present invention, an imprinted pattern may be reactive. One example of a reactive pattern is configuration of oligonucleotides printed on a substrate thereby forming an array of probes for assays.

In another embodiment consistent with the present invention, optical traps may pull a MOT or NOT against a material to cut a groove or channel in the material at a micron or submicron size. In yet another embodiment consistent with the present invention, optical traps may hammer a MOT or NOT against a material to form a well, align a structure or cause materials to collide with each other. In another embodiment consistent with the present invention, optical traps can be used to push or pull a MOT or NOT retractor.

The MOTS & NOTS which resemble wrenches, screwdrivers and the like can be used to impart a rotational force. For example, in another embodiment consistent with the present invention, a MOT or NOT wrench, contained within an optical trap, may be rotated and thereby turn a part on a MEMS device. A MOT or NOT screwdriver can fit in a slot, apply torque or be used to pry.

In another embodiment consistent with the present invention, a transponder can be placed or embedded in an optical tool for use as either a micrometer optical electrical tool (MOET) or a nanometer optical electrical tool NOET. The optical traps can be used to activate the transponder and the transponder's signal may be monitored for variations which result from an increase in mass of the MOET or NOET.

Unless otherwise specified, the optical tools described herein may be MOTS or NOTS. The optical tools described herein are constructed of a material which can be manipulated by optical traps.

In one embodiment consistent with the present invention, a construction technique for forming many of the optical tools described herein is to use a laser to drill or remove material from a tool blank, such as a microsphere. Another technique according to another embodiment consistent with the present invention, is to etch out material from a tool blank. Etching may be chemical, optical or by ion beam. Another useful construction technique according to another embodiment consistent with the present invention, which is well known in the art, is to use stereolithography to build the optical tool from an appropriate polymer. In some instances, in another embodiment consistent with the present invention, a standard lithographic technique may also be used to construct the optical tools by techniques such as etching, which techniques are generally used to form nanoscale devices.

Other features and advantages of the present invention will be set forth, in part, in the descriptions which follow and the accompanying drawings, wherein the preferred embodiments of the present invention are described and shown, and, in part, will become apparent to those skilled in the art upon examination of the following detailed description taken in conjunction with the accompanying drawings, or may be learned by practice of the present invention. The advantages of the present invention may be realized and attained by means of the instrumentalities and combinations particularly pointed out in the appendant claims.

### BRIEF DESCRIPTION OF THE DRAWINGS

FIG. 1A illustrates a side view of an optical awl or punch according to one embodiment consistent with the present invention.

FIG. 1B illustrates a perspective view of the optical awl or punch of FIG. 1A according to one embodiment consistent with the present invention.

FIG. 2 illustrates a perspective view of an optical pick according to one embodiment consistent with the present invention.

FIG. 3 illustrates a side view of a two-sided optical pick. according to one embodiment consistent with the present invention.

FIG. 4 illustrates a side view of a dual-headed optical pick according to one embodiment consistent with the present invention.

FIG. 5A illustrates a top view of an optical screwdriver according to one embodiment consistent with the present invention.

FIG. 5B illustrates a side view of the optical screwdriver of FIG. 3A according to one embodiment consistent with the present invention.

FIG. 6 illustrates a representational view of an optical drill according to one embodiment consistent with the present invention.

FIG. 7A illustrates a side view of an optical knife according to one embodiment consistent with the present invention.

FIG. 7B illustrates a front view of an optical knife according to one embodiment consistent with the present invention.

FIG. 8 illustrates a perspective view of an optical bludgeon or hammer according to one embodiment consistent with the present invention.

FIG. 9 illustrates a perspective view of a two sided optical bludgeon or hammer with anisotropic ends according to one embodiment consistent with the present invention.

FIG. 10A illustrates a perspective view of an optical capillary with one angled end according to one embodiment consistent with the present invention.

FIG. 10B illustrates a perspective view of the optical capillary with one angled end affixed to a bead according to one embodiment consistent with the present invention.

FIG. 10C illustrates a perspective view of the optical capillary formed as an optical cup with a lid according to one embodiment consistent with the present invention.

FIG. 11 illustrates a perspective view of an optical tube or capillary with anisotropic ends according to one embodiment consistent with the present invention.

FIG. 12A illustrates an optical wrench inset with square cavity according to one embodiment consistent with the present invention.

FIG. 12B illustrates an optical wrench with a protruding square head according to one embodiment consistent with the present invention.

FIG. 12C illustrates an open optical wrench with square template according to one embodiment consistent with the present invention.

FIG. 13A illustrates an optical socket with a polygonal inset cavity according to one embodiment consistent with the present invention.

FIG. 13B illustrates an optical wrench with a polygonal head according to one embodiment consistent with the present invention.

FIG. 13C illustrates an optical wrench with a polygonal template according to one embodiment consistent with the present invention.

FIG. 14A illustrates an optical screwdriver with an inset cross head according to one embodiment consistent with the present invention.

FIG. 14B illustrates an optical screwdriver with a protruding cross head according to one embodiment consistent with the present invention.

FIG. 15 illustrates a micro print array with inset character according to one embodiment consistent with the present invention.

FIG. 16 illustrates an extruded micro print array according to one embodiment consistent with the present invention.

FIG. 17 illustrates an extruded print dot according to one embodiment consistent with the present invention.

FIG. 18A illustrates a side view of an optical retractor or hoe according to one embodiment consistent with the present invention.

FIG. 18B illustrates a perspective view of the an optical retractor or hoe of FIG. 18A according to one embodiment consistent with the present invention.

FIG. 19 illustrates an optical speculum or forceps according to one embodiment consistent with the present invention.

FIG. 20 illustrates a tear drop optical tool with a radioactive end according to one embodiment consistent with the present invention.

FIG. 21 illustrates a rod-like optical tool with a magnetic end according to one embodiment consistent with the present invention.

FIG. 22 illustrates a bead-like optical tool with oppositely charged sides according to one embodiment consistent with the present invention.

FIG. 23 illustrates a MEOT with an embedded transponder and extended antenna according to one embodiment consistent with the present invention.

FIG. 24 illustrates a MEOT with an embedded transponder and antenna according to one embodiment consistent with the present invention.

FIG. 25 illustrates an optical lever according to one embodiment consistent with the present invention.

FIG. 26 illustrates an optical lever with handles according to one embodiment consistent with the present invention.

FIG. 27 illustrates an optical trap which can be used to manipulate an object with an optical tool.

### DETAILED DESCRIPTION OF THE INVENTION

The present invention provides a novel pallet of MOTS and NOTS. The MOTS and NOTS are formed of materials which are manipulated via action by one or more optical traps.

The present invention also provides a method of manipulating an object 68 (generally referred to as a workpiece) with an optical tool 69 by grasping the optical tool in the illumination 71 of an optical trap 70, optionally holding the workpiece 68 in the illumination of at least one optical trap 70 and manipulating the workpiece 68 with the optical tool 69 (see FIG. 27).

NOTS and MOTS included within the scope of the present invention, include, but are not limited to hammers, saws, drills, punches, levers, files, wrenches, screwdrivers, knives, awls, screwdrivers, and wrenches. Also included are optical tools useful to obtain fluid or particulate samples from the material under investigation. Further included are optical tools which act as a scribe to physically place a mark, patter, or label on a structure. Yet further included are optical grinders which physically cut a guide, groove, well, or channel in a material at a micron or submicron size. Still further included are optical tools with a magnetized or charged substrate, and optical tools with anisotripic functionality.

All optical tools described herein are constructed of materials which may be manipulated by optical traps. In most instances, the materials are dielectric. The surface characteristics of the MOTS and NOTS which are used to physically interact with other items may be homogeneous, or non-homogeneous. Surface characteristics which may be selected include, but are not limited to, porosity, hardness, abrasives, lubricity, and regularity. In some instances a MOT or NOT may have regions each with different surface characteristics.

In many instances the functionality of a MOT or NOT will set the parameters for the selection of the material of which it is constructed. Optical tools which are used to hammer, pry, apply torque to, cut, scratch, punch, grind, abrade, drill or file another material will preferably be constructed of a material with a high tensile strength and hardness greater than the material they are being applied to.

Although in many instances, plastic is a preferred substrate or blank material for MOTS or NOTS, in some instances suitable inorganic materials such as glass, metals, silica, diamond, quartz, chelating agents, nylon or a composite may be selected. Likewise, where appropriate, organic materials, such as proteins, lipids, nucleic acids and carbohydrates, may be selected. Any of the optical tools may have a label such as a dye, fluorophore, phosphor, quantum dot, metallic, transponder, catalytic, enzyme, or radioactive, chemiluminescent or photochromic material within the substrate which may be used to identify the MOT or NOT.

In one embodiment consistent with the present invention, to investigate materials such as plant or animal cells, organelles, proteins, polysaccharides and genetic material therein, MOTS and NOTS in the form of hollow structures which perform a capillary function may be positioned and controlled with optical traps to extract sample material which may be fluid or particulate.

MOTS and NOTS include objects functionalized to perform selected actions. MOTS and NOTS according to one embodiment consistent with the present invention, may have one or more charged, magnetic or radioactive region. MOTS and NOTS according to another embodiment consistent with the present invention, may have hydrogen bonding, hydrophobic, hydrophilic, acidic or basic regions formed thereon. Additionally, MOTS and NOTS according to yet another embodiment consistent with the present invention, may simply be a carrier particle having only the functionality of supporting the one charged, magnetic or radioactive region.

MOTS and NOTS according to another embodiment consistent with the present invention, may be formed with anisotropic functionality useful to investigate properties within materials, structures or biological systems based on the interaction of the material. For example, a MOT or NOT may have different charges, differing chemical properties (hydrophobic versus hydrophilic, or acid versus base) or differing surface regularity on each end or side. Such MOTS and NOTS exemplify functionalized optical tools according to an embodiment consistent with the present invention wherein the intended activities of the functionalized areas may be directed or localized by manipulating their supporting MOT or NOT with an optical tool. For example, in another embodiment consistent with the present invention, a chemically-functionalized portion of a MOT or a NOT may be transported to a location where the MOT or NOT is affixed to an object having on its surface a group reactive with the portion.

In another embodiment consistent with the present invention, MOTS and NOTS may be used for investigating plant and animal cells, organic and inorganic chemicals, genetic and other biological material such as proteins, ligands and polysaccharides. In yet another embodiment consistent with the present invention, the MOTS and NOTS are also useful for micro- and nano-scale fabrication of inorganic, organic and biological materials. Examples of MOT or NOT usage include building other MOTS & NOTS, constructing MEMS, building nanometer sized machines or structures, and adding or removing genetic material or proteins within a cell.

The MOTS and NOTS consistent with another embodiment of the present invention, which are contained within optical traps, may be used for imprinting a micron or submicron size pattern or identifier mark on such a material or structure as described above. The pattern may be a simple identifier such as a tag, brand or logo. The pattern may contain data such as a serial number, bar code or data matrix. Such printing, for example, may be implemented by employing soft lithography to manufacture a chip with reservoirs and a substrate. Using optical traps to grab and move beads coated with material to be imprinted, the reservoirs may be first loaded with the beads, and then the beads may be pressed against the substrate to imprint the material. In order to affix the material to the substrate, the material may be selected to be reactive with or attracted to the substrate, it may be activated by light, heat or chemicals, or it may be trapped by scratches or abrasions in the substrate. In another example, beads coated with an ink may be individually and simultaneously contacted as printing elements.

In one embodiment consistent with the present invention, an imprinted pattern may be reactive. One example of a reactive pattern is configuration of oligonucleotides printed on a substrate thereby forming an array of probes for assays.

In another embodiment consistent with the present invention, optical traps may pull a MOT or NOT against a material to cut a groove or channel in the material at a micron or submicron size. In yet another embodiment consistent with the present invention, optical traps may hammer a MOT or NOT against a material to form a well, align a structure or cause materials to collide with each other. In another embodiment consistent with the present invention, optical traps can be used to push or pull a MOT or NOT retractor.

The MOTS & NOTS which resemble wrenches, screwdrivers and the like can be used to impart a rotational force. For example, in another embodiment consistent with the present invention, a MOT or NOT wrench, contained within an optical trap, may be rotated and thereby turn a part on a MEMS device. A MOT or NOT screwdriver can fit in a slot, apply torque or be used to pry.

In another embodiment consistent with the present invention, a transponder can be placed or embedded in an optical tool for use as either a micrometer optical electrical tool (MOET) or a nanometer optical electrical tool NOET. The optical traps can be used to activate the transponder and the transponder's signal may be monitored for variations which result from an increase in mass of the MOET or NOET.

Unless otherwise specified, the optical tools described herein may be MOTS or NOTS. The optical tools described herein are constructed of a material which can be manipulated by optical traps.

In one embodiment consistent with the present invention, a construction technique for forming many of the optical tools described herein is to use a laser to drill or remove material from a tool blank, such as a microsphere. Another technique according to another embodiment consistent with the present invention, is to etch out material from a tool blank. Etching may be chemical, optical or by ion beam. Another useful construction technique according to another embodiment consistent with the present invention, which is well known in the art, is to use stereolithography to build the optical tool from an appropriate polymer. In some instances, in another embodiment consistent with the present invention, a standard lithographic technique may also be used to construct the optical tools by techniques such as etching, which techniques are generally used to form nanoscale devices.

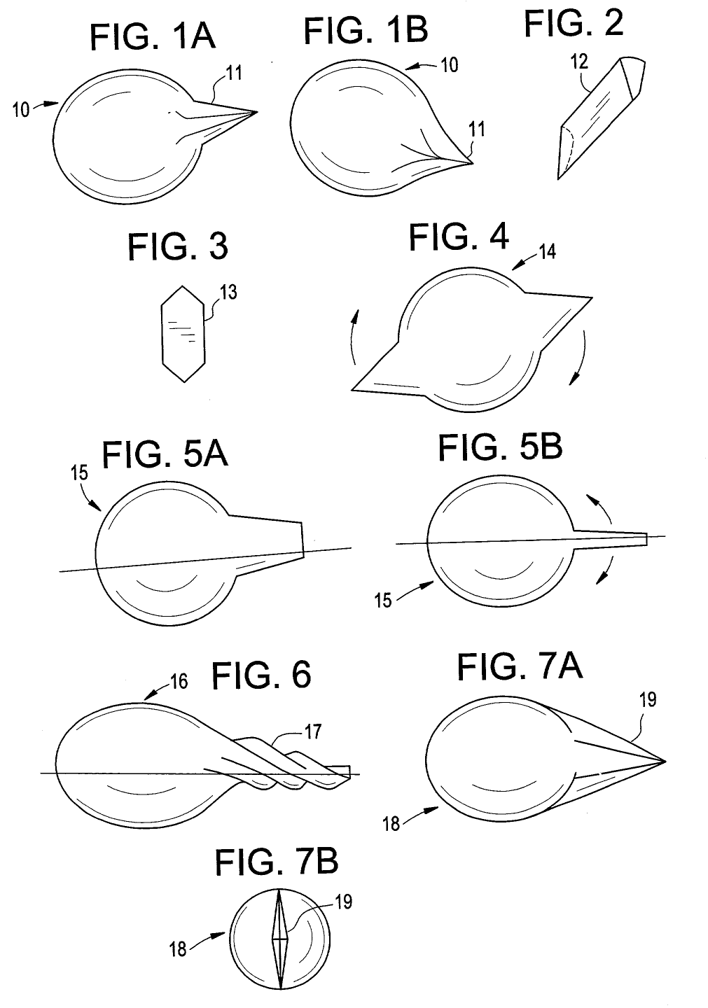

In one embodiment consistent with the present invention, as illustrated in FIGS. 1A and 1B, is an optical awl or punch 10 with an extended conical protrusion 11.

FIGS. 2 and 3 illustrate optical picks in yet another embodiment consistent with the present invention. Optical picks, such as the irregular crystal 12 of FIG. 2, and the regular crystal 13 of FIG. 3, may be used to scratch or cut a groove, slot, channel, well or guide in a material.

In another embodiment consistent with the present invention, a double-sided awl or dual punch 14 is illustrated in FIG. 4 which may also be spun utilizing the rotational forces of an optical rotator.

In another embodiment consistent with the present invention, FIGS. 5A and 5B illustrate an optical screwdriver or pry 15, in a top view and side view, respectively. The optical screwdriver 15 has a flat head and can be rotated along an axis.

In another embodiment consistent with the present invention, FIG. 6 illustrates an optical drill 16 with a drill bit 17 which can be rotated along an axis.

In another embodiment consistent with the present invention, an optical knife 18 with blade 19 as shown in FIGS. 7A and 7B can also be used to score a surface or to slice through a structure such as a cell wall or biological material.

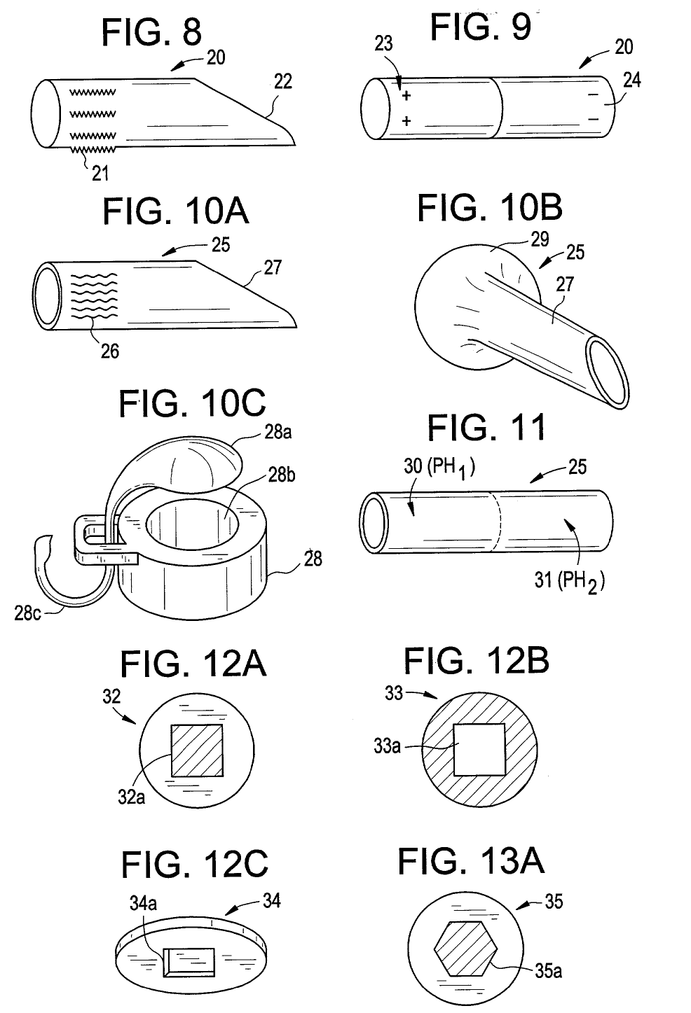

In FIGS. 8 and 9, optical hammers or bludgeons 20 in another embodiment consistent with the present invention, are illustrated. In FIG. 8, a region of surface irregularity 21 may be formed to yield a high friction zone. An angled end 22 can be provided to form a wedge.

In FIG. 9, in another embodiment consistent with the present invention, an anisotropic functionality may be incorporated into the optical hammer 20 by providing a region of positive charge 23 and a region of negative charge 24.

In another embodiment consistent with the present invention, FIGS. 10A and 10B disclose optical capillaries 25. A region of surface irregularity 26 is shown in FIG. 10A which is an area of increased lubricity. The optical capillaries 25 are tubules or slotted nibs which may have an angled end 27 and are useful for obtaining samples.

Likewise, optical tools for sampling, in another embodiment consistent with the present invention, may be in the form of hemispheres or hollow cylinders or other hollow shapes to form optical cups or cups 28 with a lid 28a (see FIG. 10C) which may be closed to

contain a sample. The optical cup 28 of FIG. 10C includes cavity 28b, and lid 28a which has hinge 28c for tilting lid 28a to cover cavity 28b in order to contain collected material therein. The optical cup 28 may be fabricated by known etching technologies, for example, in silicon.

In FIG. 10B, in another embodiment consistent with the present invention, a carbon nanotube 25 is shown covalently bonded to a latex bead 29.

In another embodiment consistent with the present invention, FIG. 11 shows a microcapillary or carbon nanotube 25 which may be used to obtain sample material. Again an anisotropic function can be attributed to the structure such as having each end 30, 31 coated with a chemical causing the acidity or basicity at each end to be different.

In other embodiments consistent with the present invention, FIGS. 12A-16 illustrate an array of different MOTS and NOTS 32-41. FIG. 12A illustrates an optical wrench 32 inset with square cavity 32a, according to one embodiment consistent with the present invention. FIG. 12B illustrates an optical wrench 33 with a protruding square head 33a, according to another embodiment consistent with the present invention. FIG. 12C illustrates an open optical wrench 34 with square template 34a, according to another embodiment consistent with the present invention.

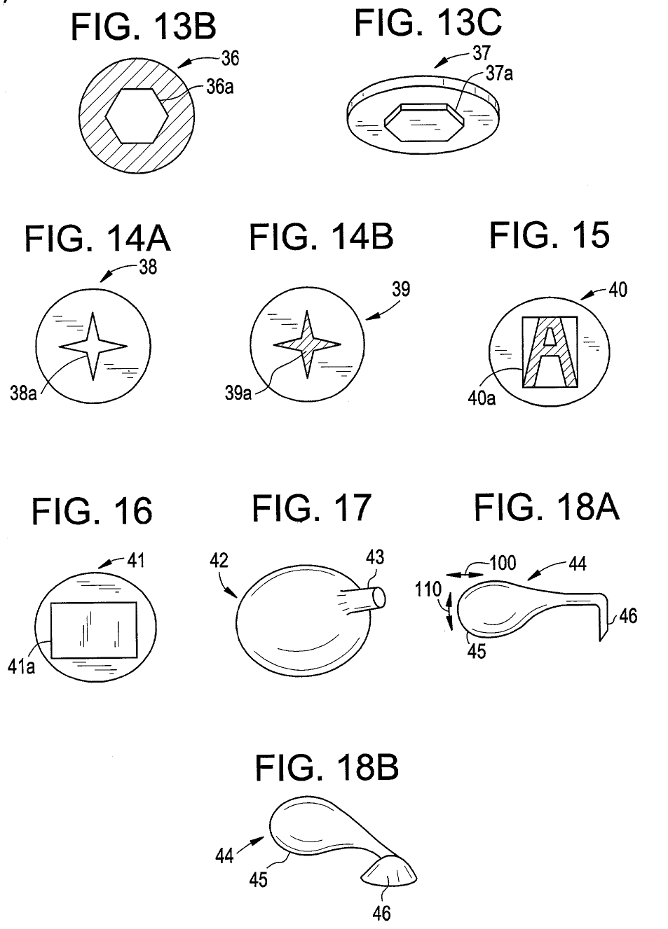

FIG. 13A illustrates an optical socket 35 with a polygonal inset cavity 35a, according to another embodiment consistent with the present invention. FIG. 13B illustrates an optical wrench 36 with a polygonal head 36a according to another embodiment consistent with the present invention. FIG. 13C illustrates an optical wrench 37 with a polygonal template 37a according to another embodiment consistent with the present invention.

FIG. 14A illustrates an optical screwdriver 38 with an inset cross head 38a, according to another embodiment consistent with the present invention. FIG. 14B illustrates an optical screwdriver 39 with a protruding cross head 39a, according to another embodiment consistent with the present invention.

FIG. 15 illustrates a micro print array 40 with inset character 40a, according to another embodiment consistent with the present invention.

FIG. 16 illustrates a micro print array 41 with extrusion 41a, according to another embodiment consistent with the present invention.

The commonality of the tools of FIGS. 12A-16 is that they are primarily used to apply torque. As previously described, an optical rotator, optical vortex, or group of optical traps may be used to apply a rotational force to the optical tools and cause them to move about a pre-determined axis of rotation.

A single MOT or NOT 40-42, as shown in embodiments consistent with the present invention of FIGS. 15-17, can impart a submicron size identifier such as a pattern, tag, brand, serial number, bar code, data matrix, or logo on a material or substrate. The method of impartation includes coating an imprinting material on the optical tool and pressing the imprinting material onto the substrate in the form of the identifier. The imprinting material is activated by light, a chemical or heat. A single dot or other simple shape 43 (see FIG. 17) can be used to imprint active materials such as oligonucleotides, antigens, antibodies, polysaccharides, or catalysts on a substrate for creating arrays for assays or for anchoring the growth of more extensive structures added by, for example, chemical synthesis. In another embodiment consistent with the present invention, a plurality of MOT and NOTS can be simultaneously manipulated with a plurality of optical traps to form a part of a more complex pattern such as a data matrix.

In another embodiment consistent with the present invention, FIGS. 18A and 18B illustrate a MOT or NOT formed in the shape of a retractor or hoe 44. The large body 45 is easily contained within an optical trap and may be pulled or pushed along the line of arrow 100. The head 46 of the retractor or hoe 44 may also be raised or lowered by using the optical trap illuminating the retractor or hoe 44 to impart a rotational force along the line of arrow 110. Retractors 44 are useful to open or pull apart structures. For example, in an embodiment consistent with the present invention, an optical knife 18 (see FIG. 7A) may be used to slice an opening in a cell membrane or wall. In another embodiment consistent with the present invention, an optical retractor 44 can be used to pull open the cut, and a MOT or NOT can be carried into the cell to perform further tasks. In another embodiment consistent with the present invention, hoes 44 may be employed as scrapers or cutters to sever connections between materials, for example, to cut the connections between a cell in a preserved tissue section and a glass microscopic slide.

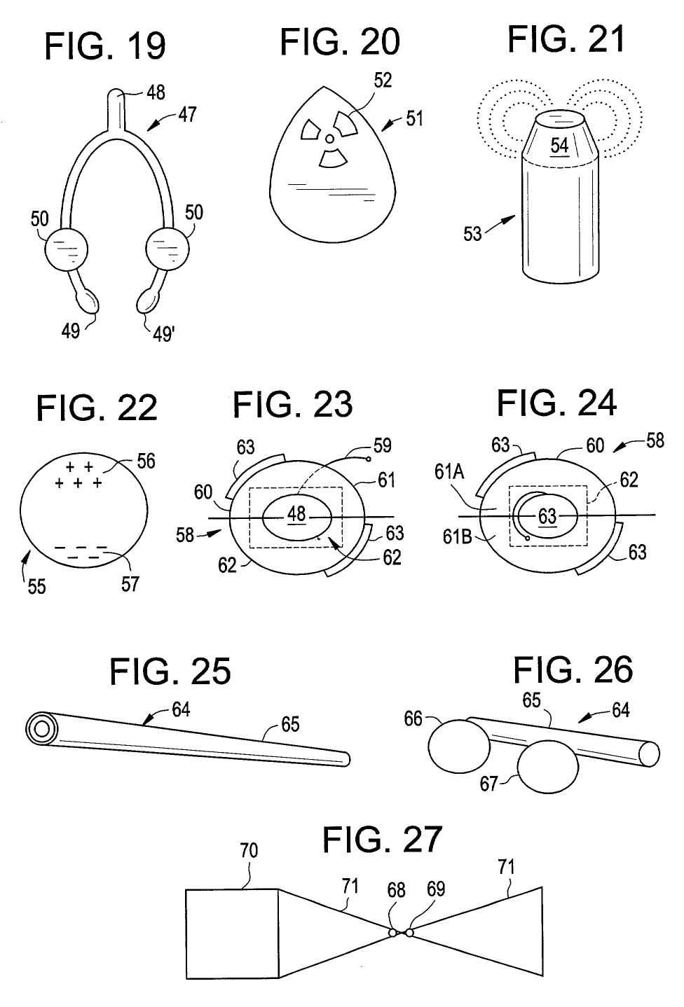

In another embodiment consistent with the present invention, an optical speculum or forceps 47 is shown in FIG. 19. One optical trap can hold the top 48 of the forceps and two additional optical traps can be used to pull apart the ends 49 and 49′ by containing and moving bead-like structures 50 and 50′.

MOTS and NOTS include objects functionalized to perform selected actions.

In another embodiment consistent with the present invention, FIG. 20 illustrates a MOT or NOT in a tear drop form 51, with radioactive material support 52 thereon (the radioactive material may be used for inducing chemical reactions in a workpiece, i.e., to kill undesirable cells).

In another embodiment consistent with the present invention, FIG. 21 illustrates a rod-like MOT or NOT 53 with a magnetic end 54 (which may be used to attract ferromagnetic or paramagnetic elements of opposite polarity in a workpiece and repel diamagnetic elements on a workpiece).

In another embodiment consistent with the present invention, FIG. 22 illustrates a bead-like MOT or NOT 55 with oppositely charged sides 56 and 57 (which may be used ot respectively attract oppositely-charged elements and repel similarly-charged elements in a workpiece).

The MOTS and NOTS exemplify functionalized optical tools wherein the intended activities of the functionalized areas may be directed or localized by manipulating their support with an optical tool. For example, the magnetic end 54 of an optical tool may be used to collect particles labeled with ferrous material and to move them to a selected location. Similarly, a chemically-functionalized portion of a MOT or a NOT may be transported to a location where the MOT or NOT is, for example, affixed to an object having on its surface a group reactive with the portion.

In another embodiment consistent with the present invention, FIGS. 23 and 24 show a representational microtransponder 58 also known as a “radio tag”. A microtransponder may be incorporated into an optical tool. FIG. 23 shows a microtransponder 58 with an extended antenna 59. In FIG. 24 the antennae 59 for the microtransponder 58 is within the optical tool body or blank 60. By constructing the optical tool body or blank 60 and housing the transponder 58 in two halves 61A and 61B, an internal cavity 62 can be formed. Within the cavity 62 the microtransponder 58 is placed.

In one embodiment consistent with the present invention, the micro transponder 58 is a radio transmitter-receiver activated for transmission by reception of a predetermined signal. A radio tag combined with an optical tool which has a surface characteristic such as a charge or oligonucleotide sequence 63, and which is selectively reactive to chemical or biologic material, may be used to interrogate the activity of chemicals, pharmaceuticals, and biological systems, including those within a cell.

In one embodiment consistent with the present invention, one example of the use of a radio tagged optical tool 58 is as a component of an array of biological probes, each optical tool internally including a radio tag 58 (a MOET or NOET), and with a known oligonucleotide 63 on its surface. An array of different probes can be constructed with a plurality of optical traps as described in pending U.S. patent application Ser. No. 09/886,802, filed Jun. 20, 2001, entitled “Configurable Dynamic Three Dimensional Array.”, which is incorporated herein by reference. The optical traps both contain the probes and can provide the signal to each probe. When a given probe hybridizes with a corresponding target material, the mass of the probe will change and the signal from the transponder will reflect the change in mass. Accordingly, the reactive probe may be easily identified.

In another embodiment consistent with the present invention, FIG. 25 illustrates an optical lever 64 having a lever arm 65, constructed of a multi-walled carbon nanotube. Single walled carbon nanotubules may also be used to form the lever 64.

In another embodiment consistent with the present invention, FIG. 26 illustrates the lever 64 of FIG. 25 with dual handles 66 and 67 affixed thereto. The handles 66, 67 are latex beads which may be chemically attached to the lever 64. The lever 64 and handles 66 and 67 may also be constructed as a single piece using the aforementioned stereo-lithographic techniques. In general, a handle 66, 67 may be described as a portion or configuration of an optical tool which is incorporated in the tool to facilitate grasping of the tool by the optical trap.

In another embodiment of the present invention, an optical tool can be used to act as the fulcrum of a lever (see FIG. 10B). Inasmuch as all optical tools may be optionally manipulated with one or more optical traps, more than one trap may exert force on a region (such as the bead structure 29) of a lever 25 on one side of a fulcrum to provide better control or adjust the amount of force applied. The force necessary for performing an action also may be distributed along an optical tool, such as an optical lever, in order to avoid applying damaging or other applying excessive force or intensity at any point.

Since certain changes may be made in the above optical tools with departure from the scope of the invention herein involved, it is intended that all matter contained in the above description, as shown in the accompanying drawings, the specification, and the claims shall be interpreted in an illustrative, and not limiting sense.

What is claimed is:

1. A method of forming an optical tool, comprising:
forming a tool from a material of a size and shape adapted for manipulation by at least one optical trap.

2. The method according to claim 1, wherein said forming step is accomplished by removing material from a tool blank.

3. The method according to claim 2, wherein said tool blank is a microsphere.

4. The method according to claim 2, wherein said material is removed by one of drilling and etching.

5. The method according to claim 1, wherein said forming step is accomplished by stereolithography using a polymer.

6. The method according to claim 4, wherein said etching step is one of chemical, optical and ion beam.

7. An optical tool comprising:
a main body formed of a material of a size and shape adapted for manipulation by at least one optical trap.

8. The optical tool according to claim 7, wherein said main body comprises a protrusion at one end.

9. The optical tool according to claim 7, wherein said main body is a substantially rectangular crystal adapted to form a pick which can form a groove or slot in a material.

10. The optical tool according to claim 8, wherein said protrusion is conical and adapted to punch a material.

11. The optical tool according to claim 8, wherein said protrusion is adapted for use as a screwdriver and said protrusion has a flat head.

12. The optical tool according to claim 10, further comprising another protrusion at another end of said main body.

13. The optical tool according to claim 12, wherein said another protrusion is conical and adapted to punch a material.

14. The optical tool according to claim 8, wherein said protrusion is a drill bit.

15. The optical tool according to claim 8, wherein said protrusion is a pointed blade adapted to cut a material.

16. The optical tool according to claim 7, wherein said main body is substantially cylindrical in shape.

17. The optical tool according to claim 16, wherein said main body is adapted for use as an optical hammer, and one end of said main body has a region of surface irregularity formed to yield a relatively increased friction zone.

18. The optical tool according to claim 17, wherein another end of said main body is formed in a shape of a wedge.

19. The optical tool according to claim 16, wherein said main body is adapted for use as an optical hammer and includes an anisotropic function.

20. The optical tool according to claim 19, wherein said anisotropic function includes one end of said main body having a region of positive charge, and another end of said main body having a region of negative charge.

21. The optical tool according to claim 16, wherein said main body is one of a microcapillary and a carbon nanotube.

22. The optical tool according to claim 21, wherein said one of microcapillary and said carbon nanotube includes an anisotropic function.

23. The optical tool according to claim 22, wherein said anisotropic function includes one end of said main body having a coating of a chemical causing acidity, and another end of said main body having a coating of a chemical causing basicity.

24. The optical tool according to claim 7, wherein said main body is adapted for use as an optical capillary.

25. The optical tool according to claim 24, wherein said optical capillary includes a region of surface irregularity, said region having a relatively increased lubricity.

26. The optical tool according to claim 24, wherein said optical capillary is one of a tubule and a slotted nib.

27. The optical tool according to claim 26, wherein said one of tubule and said slotted nib include one end in a shape of an angle.

28. The optical tool according to claim 24, wherein said optical capillary includes means for obtaining samples disposed at one end of said main body.

29. The optical tool according to claim 24, wherein said optical capillary includes means for increasing lubricity disposed at one end of said main body.

30. The optical tool according to claim 16, wherein said main body is adapted for use as an optical hammer, and one end of said main body includes means for yielding an increased friction zone.

31. The optical tool according to claim 7, wherein said main body includes means for sampling.

32. The optical tool according to claim 31, wherein said sampling means comprises one of hemispheres, hollow cylinders, and hollow devices which form optical cups.

33. The optical tool according to claim 32, further comprising a closeable lid for each of said optical cups.

34. The optical tool according to claim 24, wherein said optical capillary is a carbon nanotube with a latex bead covalently bonded at one end of said carbon nanotube.

35. The optical tool according to claim 7, wherein said main body further comprises means for applying torque.

36. The optical tool according to claim 35, wherein said torque applying means comprises an optical wrench.

37. The optical tool according to claim 36, wherein said optical wrench includes an inset cavity.

38. The optical tool according to claim 36, wherein said optical wrench includes a protruding head.

39. The optical tool according to claim 36, wherein said optical wrench is an open optical wrench including a square template.

40. The optical tool according to claim 36, wherein said optical wrench is an optical socket including a polygonal inset cavity.

41. The optical tool according to claim 36, wherein said optical wrench includes a polygonal head.

42. The optical tool according to claim 36, wherein said optical wrench includes a polygonal template.

43. The optical tool according to claim 35, wherein said torque applying means is an optical screwdriver including an inset cross head.

44. The optical tool according to claim 35, wherein said torque applying means is an optical screwdriver including a protruding cross head.

45. The optical tool according to claim 7, wherein said optical trap is used to apply a rotational force to said main body, and causes said main body to move about a predetermined axis of rotation.

46. The optical tool according to claim 7, wherein said main body is adapted for use as an optical imprinter which prints active materials on a substrate for one of creating arrays for assays and for anchoring a growth of more extensive structures.

47. The optical tool according to claim 7, wherein said optical imprinter is in a shape used to impart one of a pattern, brand, and logo on one of a material and substrate.

48. The optical tool according to claim 47, wherein said optical imprinter includes an inset character.

49. The optical tool according to claim 47, wherein said optical imprinter includes an extrusion.

50. The optical tool according to claim 7, wherein said main body is adapted for use as a retractor.

51. The optical tool according to claim 7, wherein said main body is adapted for use as a hoe.

52. The optical tool according to claim 7, wherein said main body is adapted for use as one of an optical forceps and an optical speculum.

53. The optical tool according to claim 52, further comprising a bead structure disposed on each end of said optical forceps, each said bead structure which is movable by said optical trap.

54. The optical tool according to claim 7, wherein said main body includes radioactive material.

55. The optical tool according to claim 7, wherein said main body includes a magnetic end.

56. The optical tool according to claim 7, wherein said main body includes oppositely charged sides.

57. The optical tool according to claim 55, wherein said magnetic end attracts one of ferromagnetic and paramagnetic elements of opposite polarity in a workpiece and repels diamagnetic elements in said workpiece.

58. The optical tool according to claim 7, further comprising a cavity disposed in said main body.

59. The optical tool according to claim 58, wherein a microtransponder is disposed in said cavity.

60. The optical tool according to claim 59, wherein said microtransponder includes an extended antenna.

61. The optical tool according to claim 60, wherein said microtransponder is a radio transmitter-receiver activated for transmission by reception of a predetermined signal.

62. The optical tool according to claim 61, wherein a surface characteristic of the optical tool includes one of a charge and an oligonucleotide sequence which is selectively reactive to one of chemical and biologic material.

63. The optical tool according to claim 7, wherein said main body is adapted for use as an optical lever.

64. The optical tool according to claim 63, wherein said optical lever comprises one of a single-walled and a multi-walled carbon nanotube.

65. The optical tool according to claim 64, wherein said optical lever further comprises at least one handle affixed to said optical lever.

66. The optical tool according to claim 65, wherein said handle is a latex bead chemically attached to said optical lever.

67. The optical tool according to claim 65, wherein said optical lever and said at least one handle are constructed as a single piece using stereo-lithographic techniques.

68. The optical tool according to claim 21, wherein a latex bead is bonded to said carbon nanotube.

69. The optical tool according to claim 68, wherein said latex bead is used as a fulcrum.

70. A biological probe, comprising:
a radio-tagged optical tool which is manipulated by at least one optical trap, said radio tag having a surface on which is disposed a predetermined oligonucleotide.

71. The biological probe according to claim 70, wherein said optical tool comprises a transponder.

72. A method of identifying a biological probe, comprising:
manipulating a radio-tagged optical tool using at least one optical trap;
activating a signal in a transponder in the probe using said optical trap;
hybridizing the probe with a corresponding target material;
monitoring a change in signal from said transponder which reflects a change in mass of the probe; and
identifying the probe by said change in mass.

73. The optical tool according to claim 8, wherein said protrusion is a saw blade.

74. The optical tool according to claim 7, wherein said main body is adapted for use as an optical grinder.

75. The optical tool according to claim 8, wherein said protrusion is adapted for use as a scribe.

76. A method of manipulating an object with a workpiece, comprising:
holding the workpiece with at least one optical trap;
grasping the object in an illumination of at least one optical trap; and
manipulating the workpiece with the object.

77. The method according to claim 76, wherein said object is an optical tool.

78. The method according to claim 77, wherein said optical tool is selected from a group consisting essentially of hammers, blades, picks, wrenches, saws, drills, punches, files, and screwdrivers.

79. The optical tool according to claim 61, wherein said microtransponder is adapted for use as one of a micrometer optical electrical tool (MOET) and a nanometer optical electrical tool NOET.

80. The optical tool according to claim 7, wherein said main body comprises a portion functionalized by a member of a group consisting essentially of charge, magnetic, radioactive, hydrogen bonding, hydrophobic, hydrophilic, acidic, and basic functional groups.

81. The optical tool according to claim 7, wherein said main body comprises a portion labeled with a member of a group consisting essentially of transponder, dye, metalic, quantum dot, fluorescent, chemiluminescent, phosphor, radioactive, catalytic, and enzyme labels.

82. A method of imprinting at least a submicron size identifier on a substrate comprising:
coating an imprinting material on an optical tool;
pressing said optical tool on the substrate to impart said imprinting material in a form of the submicron size identifier.

83. The method according to claim 82, wherein the submicron size identifier is one of a tag, brand, logo, serial number, bar code, and data matrix.

84. The method according to claim 82, wherein the submicron size identifier is a dot used to imprint said imprinting material which is an active material on the substrate for one of creating an array for an assay and anchoring growth of a more extensive structure.

85. The method according to claim 84, wherein said active material includes one of oligonucleotides, antigens, antibodies, polysaccharides, and catalysts.

86. The method according to claim 82, further comprising:
activating said imprinting material.

87. The method according to claim 86, wherein said activating step comprises exposing the substrate imprinted with said imprinting material to one of light, a chemical, and heat.
